(19) United States
(12) Patent Application Publication
(10) Pub. No.: US 2004/0111298 A1
(43) Pub. Date: Jun. 10, 2004

(54) Method of and system for integrating health information into a patient's record

(76) Inventor: Roy Schoenberg, Boston, MA (US)

Correspondence Address: Mark G. Lappin, McDERMOTT, WILL & EMERY, 28 State Street, Boston, MA, 02109, US

(21) Appl. No.: 10/315,514

(22) Filed: Dec. 10, 2002

(51) Int. Cl. G06F 17/60

(52) U.S. Cl. 705/3

(57) ABSTRACT

A method of integrating information into a record includes the steps of:

A. constructing, with a user system, a personalized record on a first data server system;

B. selecting a topic about which information will be integrated into the record;

C. the first data server system locating a second data server system on a network which contains information about the topic;

D. the first data server system generating, within the record, a link to the location within the second data server system which contains the information;

E. the user system accessing the record on the first data server system via the network;

F. the user system selecting the link within the record;

G. the first data server system retrieving the information associated with the link from the second data server system via the network; and

H. the first data server system transmitting the information to the user system via the network.

### FIELD OF THE INVENTION

This invention generally relates to a method of and system for integrating health information into a patient's record, and more specifically to a method of and system for retrieving information specific to a patient's condition and integrating it into an online medical record which is accessible by the patient.

### BACKGROUND OF THE INVENTION

There is a vast amount of medical information available on the internet, including general information about specific medical conditions, treatments for the conditions, symptoms of the conditions, lifestyle tips for the prevention or management of the conditions, etc. There are also many search engines which may be used to attempt to locate such information. However, while the information that a patient is looking for may be available from such search engines, finding relevant information that is reliable and from a trustworthy source can be very difficult and time consuming.

### SUMMARY OF THE INVENTION

The present invention is directed to an online patient information system which enables a patient to access his or her private medical records which are stored on a secure platform server system. Included within the records are links to information relevant to conditions suffered by the patient, information relevant to prescribed drugs being administered to the patient, lifestyle information that is of interest to the patient and any general information which might be of interest to the patient.

According to one aspect of the invention, a method of integrating information into a record includes:

A. constructing, with a user system, a personalized record on a first data server system;

B. selecting a topic about which information will be integrated into the record;

C. the first data server system locating a second data server system on a network which contains information about the topic;

D. the first data server system generating, within the record, a link to the location within the second data server system which contains the information;

E. the user system accessing the record on the first data server system via the network;

F. the user system selecting the link within the record;

G. the first data server system retrieving the information associated with the link from the second data server system via the network; and

H. the first data server system transmitting the information to the user system via the network.

The record may be a health record. The first data server system may host a website through which the user system accesses the record. The user system may gain access to the information through the website. In step A, the record may be constructed by a patient using the user system. In step A, the record may be constructed by a healthcare provider using the user system. The network may be the internet.

According to another aspect of the invention, a system for integrating information into a record includes a first data server including a computer processor and associated memory, the first data server having a database containing at least one record, the record including data pertaining to a user of the system and a second data server system including a computer processor and associated memory and being coupled to the first data server system via a network, the second data server system including information categorized into at least one topic. The record further includes a link to the information in the at least one topic stored on the second data server system, such that, when the user selects the link from within the record, the first data server system retrieves the information stored on the second data server system via the network and transmits the information to the user via the network.

The system may further include a user system including a computer processor and associated memory wherein the record is constructed on the first data server system by the user system. The record may be constructed by a patient using the user system. The record may be constructed by a healthcare provider using the user system. The network may be the internet.

According to yet another embodiment of the invention, a method of integrating information into a record includes:

A. constructing, with a user system, at least one data record on a first data server system, the at least one data record including information categorized into at least one category;

B. searching each of the at least one data records to locate particular entries in each of the at least one category;

C. locating a data record having the particular entries in each of the at least one category;

D. associating a topic with the located data record;

E. the first data server system locating a second data server system on a network which contains information about the topic;

F. the first data server system generating, within the located data record, a link to the location within the second data server system which contains the information;

G. the user system accessing the located data record on the first data server system via the network;

H. the user system selecting the link within the located data record;

I. the first data server system retrieving the information associated with the link from the second data server system via the network; and

J. the first data server system transmitting the information to the user system via the network.

### BRIEF DESCRIPTION OF THE DRAWINGS

The foregoing and other objects of this invention, the various features thereof, as well as the invention itself may be more fully understood from the following description when read together with the accompanying drawings in which:

FIG. 1 is a diagrammatic view of a system for distributing medical information in accordance with the present invention; and

FIG. 2 is a flow diagram showing the steps involved in integrating information into a patient's records in accordance with the present invention.

### DETAILED DESCRIPTION

The present invention provides a patient with access to information relevant to his or her personal conditions or interests by incorporating links to the information stored on a trusted repository server system, such that the patient receives up-to-date, relevant information pertaining to the customer's specific needs. Upon setting up the customer's record on a platform server to which the patient subscribes, links to the pertinent information are constructed within the patient's record, to enable the patient to access the information without having to search the internet for it.

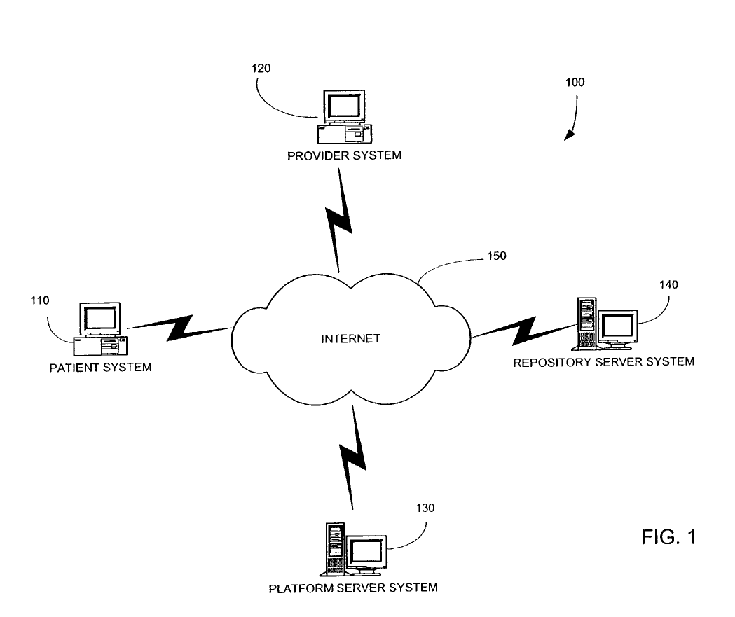

FIG. 1 shows a diagram of a system 100 for integrating information from a trusted information repository server system into a patient's record in accordance with a preferred embodiment of the present invention. The system 100 includes a patient system 110, provider system 120, secure platform server system 130 and a repository server system 140 all connected to a common communications network 150. Preferably, the patient system 110, provider system 120, secure platform server system 130 and repository server system 140 can each be a personal computer such as an IBM PC or IBM PC compatible system or an APPLE® MacINTOSH® system or a more advanced computer system such as an Alpha-based computer system available from Compaq Computer Corporation or SPARC® Station computer system available from SUN Microsystems Corporation, although a main frame computer system can also be used. Preferably, the communications channel 150 is a TCP/IP-based network such as the Internet or an intranet, although almost any well known LAN, WAN or VPN technology can be used.

In one embodiment of the invention, the patient system 110 and provider system 120 are IBM PC compatible systems operating a Microsoft Windows® operating system and secure platform server system 130 and repository server system 140 are configured as web servers providing access to information such as web pages in HTML format via the HyperText Transport Protocol (http). The patient system 110 and provider system 120 include software to allow viewing of web pages, commonly referred to as a web browser, thus being capable of accessing web pages located on platform server system 130. Furthermore, patient system 110, provider system 120, platform server system 130 and host server system 140 include software for encrypting and decrypting data that is transmitted over the communications network 150. Alternatively, patient system 110 and provider system 120 can be any wired or wireless device that can be connected to a communications network, such as an interactive television system, such as WEBTV, a personal digital assistant (PDA) or a cellular telephone. In this preferred embodiment, patient system 110 is located at the patient's home or primary care physician's office and provider system 120 is located wherever access to a patient's medical record is required, such as in an emergency room, ambulance or another doctor's office.

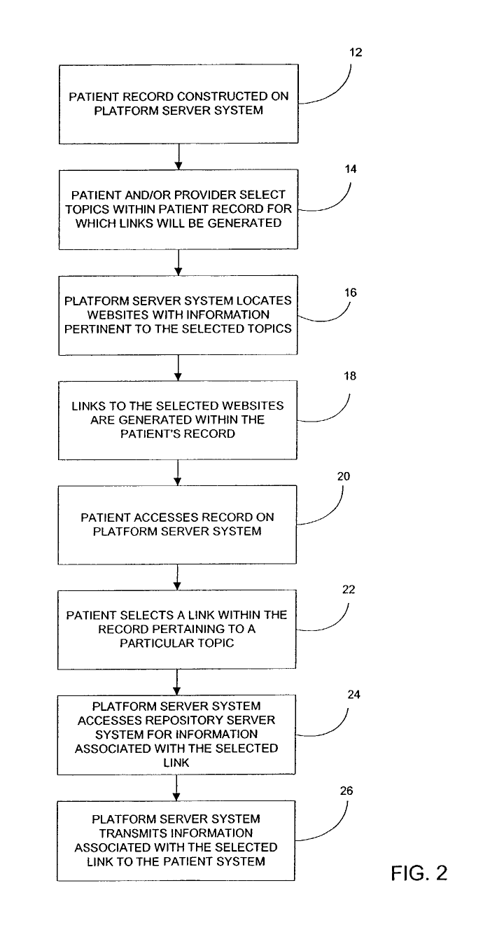

FIG. 2 shows a flow diagram of the method of integrating information from a trusted information repository server system into a patient's record in accordance with a preferred embodiment of the present invention. In step 12, the patient record is constructed on the platform server system 130. This can be done by downloading the information from another online patient record system, or the record can be manually generated on the platform server system 130 by means of a template data entry system, for example. The platform server system 130 includes a security device that allows only a subscriber to the platform server system 130 to construct or edit a patient record. The subscriber may be the patient, or the patient's healthcare provider, who may access the platform server system 130 via provider system 120. Once constructed, the record is stored in a database of the platform server system 130.

After the patient record is constructed on the platform server system, the patient and/or provider select from a number of topics of information that are pertinent to the patient, based on the information in the patient's record. In one embodiment of the invention, the patient or provider will select from a menu of available topics or the provider may set indicator flags within the patient's record that indicate to the platform server system that the patient has a particular condition about which information is desired. In another embodiment of the invention, the platform server system will include a parser which evaluates the data input to the patient's record and, based on the evaluation of the data, provides a list of topics that are relevant to the patient's record. Exemplary topics include diseases and conditions that the patient might have, prescriptions which are being administered to the patient and lifestyle information for the prevention or maintenance of certain conditions to which the patient may be susceptible. The selected topics can be automatically added to the patient's record or the patient can select from the list of topics, step 14.

Furthermore, the platform server system 130 may include an automated mechanism for searching the patient records stored on the system to locate and flag patients who fit into a particular category or categories of interest and to direct relevant content and services to the flagged patients. For example, the platform server system 130 may be programmed to search the patient records to locate female patients over age 55 who are diabetic and have had breast cancer. Once patients who fit these parameters are located and flagged, links to information and services relevant to these patients can be constructed such that the information and services can be automatically directed to the patient when she accesses her record on the platform server system 130.

The platform server system 130 then locates websites which contain the information desired to be included in the record by the patient, step 16. Preferably, the websites located by the platform server system 130 are part of a trusted repository server system 140, to which the platform server system defaults when seeking the desired information. Such a trusted repository server system may include the MayoClinic.com website, for example. Alternatively, the platform server system 130 may access discrete servers to obtain the required information. Once the particular website for a selected topic is located by the platform server system 130, the platform server system generates a link to the website within the patient's record, step 18. These links are coded within the patient's record in a manner known in the art.

Once the patient's record is set up according to steps 12-18, the patient may then access his or her record by “logging on” to the website hosted by the platform server system 130, in a manner known in the art. After the patient enters the required security information, the patient is granted access to his or her record, step 20. The record is then viewable on the platform server system website by the patient. The patient is than able to select any links that may have been set up by the patient or healthcare provider. For example, if the patient has been diagnosed with high blood pressure, a link to information pertaining to high blood pressure may have been generated by the platform server system under the direction of the patient or healthcare provider. The patient would be able to select the link, step 22, in which case the platform server system 130 would retrieve the information associated with the link from the repository server system 140, step 24, which information is then transmitted to the patient system 110 by the platform server system 130, step 26.

Since the information is retrieved from the repository server system 140 and not statically stored on the platform server system or in the patient's record, the information is up-to-date, based on the ability of the information stored on the repository server system 140 to be constantly updated and reviewed by the operators of the repository server system 140. This enables the patient to be provided with the most relevant information pertaining to the particular topic of the patient's record.

As described above, the record may be accessible and updateable by the healthcare provider via the provider system 130, such that the patient may be presented with new health-related information in the record which the healthcare provider deems would be beneficial to the patient. If, for example, a study has concluded that a particular diet or exercise regimen has been determined to lessen the effects of the patient's high blood pressure, the healthcare provider may access the patient's record to instruct the platform server system 130 to generate a link to the pertinent information on the repository server system 140.

In the preferred embodiment, platform server system of the present invention provides the linked information to the patient through the website that it hosts. Accordingly, the patient only needs to access the website of the platform server system 130. Since the links are generated within each patient's record, each patient is presented with information that is specifically tailored to that patient. Furthermore, because all of the links to the repository server system 140 are transmitted through the platform server system 130, the repository server system never has access to any information of the patient, both personal information within the patient's record and identification information that may be obtained by the repository server system 140 if the patient system 110 were to access the repository server system 140 directly.

Accordingly, the present invention provides a method of and system for integrating information into the record of a patient. The system includes a platform server system 130 on which the patient record is stored and a repository server system 140 on which information in a wide variety of topics is stored. Each record is configurable to include links to information on the repository server system 140. The linked information is provided to the patient via the platform server system website. Since the information on the repository server system 140 is continuously updated and reviewed, the patient is provided with up-to-date information whenever he or she accesses his or her record on the platform server system 130. The system provides a convenient and user-friendly way for the patient to obtain information that is pertinent to their condition.

While the present invention has been described with respect to the integration of health-related information into a patient's medical record, it will be understood that the invention may be used to integrate any type of information into a record of a person having a need to know the information. For example, the invention may be used to integrate automotive information such as recalls or maintenance information for a particular automobile into a person's record set up on an appropriate platform server system.

The system and method may be embodied in other specific forms without departing from the spirit or essential characteristics thereof. The present embodiments are therefore to be considered in respects as illustrative and not restrictive, the scope of the system and method being indicated by the appended claims rather than by the foregoing description, and all changes which come within the meaning and range of the equivalency of the claims are therefore intended to be embraced therein.

1. A method of integrating information into a record comprising:
A. constructing, with a user system, a data record on a first data server system;
B. selecting a topic about which information will be integrated into the record;
C. said first data server system locating a second data server system on a network which contains information about the topic;
D. said first data server system generating, within the record, a link to the location within the second data server system which contains the information;
E. said user system accessing the record on the first data server system via the network;
F. said user system selecting the link within the record;
G. said first data server system retrieving the information associated with the link from the second data server system via the network; and
H. said first data server system transmitting the information to the user system via the network.

2. The method of claim 1 wherein said record is a health record.

3. The method of claim 1 wherein said first data server system hosts a website through which said user system accesses the record.

4. The method of claim 3 wherein said user system gains access to said information through said website.

5. The method of claim 2 wherein, in step A, said record is constructed by a patient using said user system.

6. The method of claim 2 wherein, in step A, said record is constructed by a healthcare provider using said user system.

7. The method of claim 1 wherein said network is the internet.

8. A system for integrating information into a record comprising:
a first data server including a computer processor and associated memory, said first data server having a database containing at least one record, the record including data pertaining to a user of the system; and
a second data server system including a computer processor and associated memory and being coupled to said first data server system via a network, said second data server system including information categorized into at least one topic;
wherein the record further includes a link to the information in the at least one topic stored on said second data server system, such that, when the user selects the link from within the record, the first data server system retrieves the information stored on said second data server system via the network and transmits the information to the user via the network.

9. The system of claim 8 wherein said record is a health record.

10. The system of claim 8 wherein said first data server system hosts a website through which said user accesses the record.

11. The system of claim 10 wherein the user gains access to said information through said website.

12. The system of claim 9 further comprising a user system including a computer processor and associated memory wherein said record is constructed on said first data server system by the user system.

13. The system of claim 12 wherein said record is constructed by a patient using said user system.

14. The system of claim 12 wherein said record is constructed by a healthcare provider using said user system.

15. The system of claim 8 wherein said network is the internet.

16. A method of integrating information into a record comprising:
A. constructing, with a user system, at least one data record on a first data server system, said at least one data record including information categorized into at least one category;
B. searching each of said at least one data records to locate particular entries in each of said at least one category;
C. locating a data record having the particular entries in each of said at least one category;
D. associating a topic with the located data record;
E. said first data server system locating a second data server system on a network which contains information about the topic;
F. said first data server system generating, within the located data record, a link to the location within the second data server system which contains the information;
G. said user system accessing the located data record on the first data server system via the network;
H. said user system selecting the link within the located data record;
I. said first data server system retrieving the information associated with the link from the second data server system via the network; and
J. said first data server system transmitting the information to the user system via the network.

17. A method of integrating information into a record comprising:
A. constructing, with a user system, a data record on a first data server system;
B. assigning an informational topic to the record;
C. said first data server system locating a second data server system on a network which contains information about the topic;
D. said first data server system generating, within the record, a link to the location within the second data server system which contains the information;
E. said user system accessing the record on the first data server system via the network;
F. said user system selecting the link within the record;
G. said first data server system retrieving the information associated with the link from the second data server system via the network; and
H. said first data server system transmitting the information to the user system via the network.
